(19) United States
(12) Patent Application Publication
(10) Pub. No.: US 2025/0199208 A1
(43) Pub. Date: Jun. 19, 2025

(54) SOLID MATERIAL INCLUDING A SURFACE EXCELLENT IN ANTIFOGGING PROPERTY AND SLIPPERINESS, SURFACE FORMING MATERIAL, OPTICAL MEMBER, AND A PAIR OF EYEGLASSES

(71) Applicant: Canon Optron, Inc., Ibaraki (JP)

(72) Inventors: Manabu KONAGAI, Ibaraki (JP); Moritada TOMATSU, Ibaraki (JP)

(21) Appl. No.: 19/063,562

(22) Filed: Feb. 26, 2025

Related U.S. Application Data
(63) Continuation of application No. PCT/JP2023/030023, filed on Aug. 21, 2023.

(30) Foreign Application Priority Data
Sep. 9, 2022 (JP) 2022-144016

(51) Int. Cl. G02B 1/18; C09D 1/00; C09D 7/63; C09D 7/65

(52) U.S. Cl. CPC G02B 1/18; C09D 1/00; C09D 7/63; C09D 7/65

(57) ABSTRACT

Provided are a solid material excellent in both of an antifogging property and slipperiness, an optical member, and a pair of eyeglasses. Specifically, provided is a solid material including a surface containing at least a component A and a component B. The component A is a silicon compound having a silanol group. The component B is a compound having an alkyl group having 18 or more carbon atoms in a main chain. A composition ratio R_{B}/R_{A} of the component B to the component A in the surface is 0.23 or more and 8.89 or less.

### CROSS-REFERENCE TO RELATED APPLICATIONS

This application is a continuation application of International Application No. PCT/JP2023/030023, filed Aug. 21, 2023, which claims the benefit of Japanese Patent Application No. 2022-144016, filed Sep. 9, 2022, both of which are hereby incorporated by reference herein in their entirety.

### BACKGROUND OF THE INVENTION

### Field of the Invention

The present disclosure relates to a solid material including a surface excellent in antifogging property and slipperiness, an optical member including the solid material, and a pair of eyeglasses including the optical member.

The present disclosure also relates to a surface forming material for forming a surface excellent in antifogging property and slipperiness, a solid material including a surface formed through use of the surface forming material, an optical member including the surface, and a pair of eyeglasses including the optical member.

### Description of the Related Art

Most eyeglass lenses each have a water-repellent thin film formed on an outermost layer in order to prevent the adhesion of dirt, such as fingerprints, sebum, sweat, and cosmetics, and facilitate the removal thereof (Japanese Patent No. 5956843). When such water-repellent thin film is formed, the surface free energy of the eyeglass lens is reduced, and the slipperiness thereof becomes satisfactory, with the result that the dirt on the eyeglass lens can be easily wiped off. However, a related-art eyeglass lens having a water-repellent thin film formed thereon has a problem in that, when moisture, such as steam or exhaled breath, adheres to the eyeglass lens, the moisture becomes minute liquid droplets to cover the surface, to thereby cause the surface to become foggy.

Several technologies for preventing lens fogging have been proposed. There has been known a technology for preventing fogging by covering a lens surface with a compound having a hydrophilic group such as a silanol group (Si—OH) to achieve uniform wetting and spreading of water droplets that adhere to the lens surface (Japanese Patent No. 3435136). However, although a lens having such hydrophilic surface has antifogging performance, such lens has a problem of having low slipperiness and being unsuitable for wiping off dirt.

In addition, there has been known a base polyolefin-based resin film including a layer made of a resin composition obtained by copolymerization with a metallocene catalyst, in which an ethylene-α-olefin copolymer resin and a high-density polyethylene resin are blended (Japanese Patent Application Laid-Open No. 2009-148267). In Japanese Patent Application Laid-Open No. 2009-148267, there are descriptions of the speed of expression of the antifogging property of the film and the sustained antifogging effect thereof, but there is no mention of the slipperiness thereof.

It cannot be said that the solving means described in Japanese Patent No. 5956843, Japanese Patent No. 3435136 and Japanese Patent Application Laid-Open No. 2009-148267 are sufficient in terms of satisfying both of an antifogging property and slipperiness, and there has been a demand for a surface excellent in both of an antifogging property and slipperiness. That is, an object of the present disclosure is to provide a solid material excellent in both of an antifogging property and slipperiness, an optical member, and a pair of eyeglasses. Another object of the present disclosure is to provide a surface forming material for forming a surface that satisfies both of an antifogging property and slipperiness.

### SUMMARY OF THE INVENTION

The present disclosure provides a solid material including a surface containing at least a component A and a component B, wherein the component A is a silicon compound having a silanol group, wherein the component B is a compound having an alkyl group having 18 or more carbon atoms in a main chain, and wherein a composition ratio R_{B}/R_{A} of the component B to the component A in the surface is 0.23 or more and 8.89 or less. Further, the present disclosure provides an optical member including the solid material, and a pair of eyeglasses including the optical member.

In addition, the present disclosure provides a surface forming material including at least a component A′ and a component B, wherein the component A′ is a silicon compound having an alkoxy group, wherein the component B is a compound having an alkyl group having 18 or more carbon atoms in a main chain, and wherein a mass ratio of the component B to the component A′ in the surface forming material is 0.01 or more and 0.41 or less.

Further, the present disclosure provides an optical member including a surface formed through use of the surface forming material, and a pair of eyeglasses including the optical member.

According to the present disclosure, the solid material including a surface that satisfies both of an antifogging property and slipperiness, and the optical member and the pair of eyeglasses each including the surface can be provided. In addition, the surface forming material for forming a surface that satisfies both of an antifogging property and slipperiness can be provided.

### BRIEF DESCRIPTION OF THE DRAWINGS

FIG. 1 is a schematic view for illustrating the configuration in a first embodiment of a solid material.

FIG. 2 is a schematic view for illustrating the configuration in a second embodiment of a solid material.

FIG. 3 is a schematic view for illustrating the configuration in a first embodiment of an optical member.

FIG. 4 is a schematic view for illustrating the configuration in a second embodiment of an optical member.

FIG. 5 is a schematic view for illustrating the configuration in one embodiment of a pair of eyeglasses.

### DESCRIPTION OF THE EMBODIMENTS

Embodiments of a solid material including a surface, a surface forming material, an optical member including the surface, and a pair of eyeglasses including the optical member according to the present disclosure are described below by way of exemplary embodiments. In addition, the present disclosure is not limited to the following embodiments.

In addition, in the present disclosure, the description “XX or more and YY or less” or “XX to YY” representing a numerical range means a numerical range including a lower limit and an upper limit that are end points unless otherwise stated. Further, when the numerical ranges are described in stages, the upper and lower limits of each numerical range may be freely combined.

According to the present disclosure, fogging caused by exposure of a base material or an optical member to exhaled breath or steam at the time of use can be prevented, the frictional force in a range of loads applied to the surface of the base material or the optical member when a user uses the base material or the optical member in daily life can be reduced, and an antifogging characteristic can be expressed. As a result, a solid material including a surface that satisfies both of an antifogging property and slipperiness, an optical member including the surface, and a pair of eyeglasses including the optical member can be provided. In addition, a surface forming material that imparts the above-mentioned characteristics to a surface layer can be provided.

According to an embodiment of the present disclosure, there is provided a solid material including a surface containing at least a component A and a component B, wherein the component A is a silicon compound having a silanol group, wherein the component B is a compound having an alkyl group having 18 or more carbon atoms in a main chain, and wherein a composition ratio R_{B}/R_{A} of the component B to the component A in the surface is 0.23 or more and 8.89 or less.

The inventors have conceived the mechanism by which the solid material and the optical member according to the present disclosure satisfy both of an antifogging property and slipperiness to be as described below.

As the component A in the surface of the solid material or the optical member according to the present disclosure, a silicon compound having a silanol group is selected. In addition, as the component B in the surface of the solid material or the optical member according to the present disclosure, a compound having an alkyl group having 18 or more carbon atoms in a main chain is selected.

The component A has a silanol group and hence expresses an antifogging characteristic, but the surface including the component A has an increased frictional force when a load is applied. Meanwhile, the component B is a compound having an alkyl group having 18 or more carbon atoms in a main chain, and hence the surface including the component B tends to have a decreased frictional force to allow a loaded target to easily slip when a load is applied as compared to the surface including the component A. Meanwhile, the surface including the compound having an alkyl group having less than 18 carbon atoms in a main chain does not exhibit sufficient slipperiness when a load is applied.

Thus, when the solid material including the surface containing at least the component A and the component B is brought into contact with an object, the component B easily causes a low frictional force with respect to the object as compared to the component A. When the ratio at which the component B is brought into contact with the object that is brought into contact with the surface is increased, the frictional force with respect to the object is decreased.

When the composition ratio of the component B to the component A in the surface is adjusted so as to fall within a predetermined range after the foregoing is considered, a high antifogging characteristic is obtained when moisture, such as steam or exhaled breath, adheres to the surface.

The “surface” refers to a surface that forms the outer side of an object. The term “base material” as used herein particularly refers to a substrate or an article to which the surface having an antifogging property or slipperiness is given, and refers to, for example, a substrate or an article made of glass, a ceramic, a resin, a metal, or a mixture thereof.

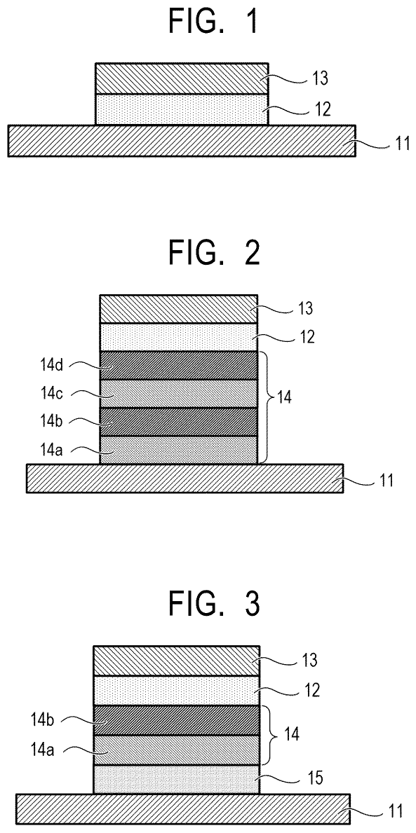

The “solid material” refers to a material having a specific shape, and the “solid material” in the present disclosure particularly refers to a material having the surface with an antifogging property or slipperiness given thereto or a part thereof. The “solid material” as used herein may or may not include a base material. That is, the “solid material” of the present disclosure may refer to a thin layer to which an antifogging property or slipperiness is imparted, or may refer to a material including both of the thin layer and the base material. For example, in an example in FIG. 1 described later, the solid material may include a base material 11, a base layer 12, and a surface 13, may refer to the base layer 12 and the surface 13, or may refer to only the surface 13.

The “solid material including the surface containing the component A and the component B” means that the component A and the component B are present in the surface of the solid material, more specifically, that an element derived from the component A and an element derived from the component B are detected when the surface is measured by X-ray photoelectron spectroscopy, or that the surface of the solid material is formed of a material containing the component A or a precursor of the component A and the component B or a precursor of the component B. When the solid material contains the component A and the component B in the surface, the material for the base material is not limited, and the base material may be glass, a ceramic, a resin, or a metal, or a film formed of glass, a resin, or the like.

An optical member encompasses an optical filter, an optical lens, an eyeglass lens, a photographic lens, a cover glass for a display, a touch panel for a display, various films, and the like. The optical member of the present disclosure particularly refers to an optical member having a surface with an antifogging property or slipperiness given thereto, and is an optical member that includes the solid material or that is the solid material.

The pair of eyeglasses of the present disclosure is a pair of eyeglasses including the above-mentioned optical member. The pair of eyeglasses encompasses all devices to be worn around the eyes, and encompasses a pair of eyeglasses to be worn for appearance's sake, a pair of protective goggles, a head mounted display, a pair of sunglasses, a pair of smart glasses, and the like without being limited to a pair of eyeglasses for vision correction to be typically used.

The component A in the present disclosure is described.

The component A is a silicon compound having a silanol group. The “silanol group” refers to a group formed of a Si atom and —OH bonded thereto. The silicon compound is preferably silicon monoxide or silicon dioxide, more preferably silicon dioxide.

The component B in the present disclosure is described.

The component B is a compound having an alkyl group having 18 or more carbon atoms in a main chain. The “main chain” refers to a molecular chain that forms the skeleton of a molecular structure of the compound. The component B preferably contains at least one selected from a polyolefin and a fatty acid salt. The “polyolefin” refers to polyethylene, polypropylene, or a copolymer of polyethylene and polypropylene. Examples of the polyethylene may include low-density polyethylene (LDPE), high-density polyethylene (HDPE), and medium-density polyethylene (MDPE). The fatty acid salt is preferably a salt formed of at least one metal element selected from the group consisting of: an alkali metal; an alkaline earth metal; and a transition metal, and a saturated fatty acid or an unsaturated fatty acid, more preferably cerium stearate, aluminum stearate, or calcium stearate. The component B preferably contains at least one selected from the group consisting of: a copolymer of polyethylene and polypropylene; and cerium stearate. The polyolefin and the fatty acid salt may contain substituents. The molecular weight of the polyolefin is preferably 900 or more and 7,200 or less, more preferably 900 or more and 4,000 or less, still more preferably 900 or more and 2,000 or less. The component B does not contain Si in the chemical formula thereof.

Specific examples of the component B include polyethylene (Hi-WAX 100P (B-6), manufactured by Mitsui Chemicals, Inc.), an ethylene-propylene copolymer (Hi-WAX 110P (B-4), Hi-WAX 210P (B-7), and Hi-WAX 720P (B-8), all manufactured by Mitsui Chemicals, Inc.), an oxidized product of an ethylene-propylene copolymer (Hi-WAX 4202E (B-2) and Hi-WAX 220MP (B-3), both manufactured by Mitsui Chemicals, Inc.), a maleic anhydride-modified product of an ethylene-propylene copolymer (Hi-WAX 1105A (B-1), manufactured by Mitsui Chemicals, Inc.), a styrene-grafted product of an ethylene-propylene copolymer (Hi-WAX 1120H (B-5), manufactured by Mitsui Chemicals, Inc.), cerium stearate (B-9), aluminum stearate (B-10), and calcium stearate (B-11).

The composition ratio of the component B to the component A of the solid material is represented by R_{B}/R_{A}, where the R_{A} represents a value derived from the component A and the R_{B} represents a value derived from the component B when the surface is measured by X-ray photoelectron spectroscopy. The R_{B}/R_{A} may be expressed in a range of from 0.23 to 8.89 in the surface of the solid material of the present disclosure.

In addition, the composition ratio R_{B}/R_{A} of the component B to the component A in the surface of the present disclosure may be adjusted by the mass ratio of the component B to a component A′ in the surface forming material to be used in the formation of the surface, and the mass ratio of the component B to the component A′ in the surface forming material is 0.01 or more and 0.41 or less.

When the composition ratio of the component B to the component A is less than 0.23, the solid material has a drawback in ease of use, such as the cloth getting caught when dirt is wiped off. In addition, when the composition ratio of the component B to the component A is more than 8.89, the solid material is suitable for wiping off dirt, but antifogging performance is decreased.

The surface of the solid material may contain another component except the component A and the component B. However, the ratio of the component A and the component B to the composition of the surface is preferably 95% or more, more preferably 98% or more. That is, when the component except the component A and the component B is defined as another component, the surface of the solid material includes the component A, the component B, and another component, and the composition ratio R_{(A+B)}/R_{(A+B+other)} of the total of the component A and the component B to the total of the component A, the component B, and the other component in the surface is preferably 0.95 or more, more preferably 0.98 or more. The other component is not limited, but an example thereof may be Al₂O₃.

The composition ratio of the component B to the component A, and the composition ratio of the total of the component A and the component B to the total of the component A, the component B, and the other component in the surface of the solid material may be determined by the following method. However, the determination of the composition ratio of the component B to the component A is not limited to the following method.

First, a region of the surface to be measured by X-ray photoelectron spectroscopy is determined based on the output of an X-ray irradiation device included in an apparatus and the diameter of X-ray irradiation. The region determined as described above is hereinafter also referred to as “measurement region.”

Next, the measurement region is irradiated with an X-ray, and the spectra of binding energy of elements are obtained from kinetic energy of generated photoelectrons. The measurement conditions may be set as described below.
Measurement apparatus: X-ray photoelectron spectrometer Quantera SXM manufactured by ULVAC-PHI, Incorporated
X-ray output: Al-Kα ray (E=1,486.6 eV), 15 kV, 50 W
Measurement region: 200 μmϕ
Substrate: borosilicate glass

The elemental composition ratio of the measurement region is calculated from C1s, Si2p, and B1s spectra among the resultant spectra. The carbon concentration calculated from the C1s spectrum is represented by S_{C}, and similarly, the silicon concentration and the boron concentration are represented by S_{Si} and S_{B}, respectively. Next, the atomic concentrations of respective elements calculated from the Si2p and B1s spectra measured only for the substrate are represented by B_{Si} and B_{B}. A value R_{A} derived from the component A and a value R_{B} derived from the component B are determined by the following calculation formulae, and the composition ratio of the component B to the component A is determined by dividing the R_{B} by the R_{A}.

$${R}_{A} = {S}_{Si} - ( \frac{{B}_{Si}}{{B}_{B}} \times {S}_{B} )$$

$${R}_{B} = {S}_{C}$$

The composition ratio R_{(A+B)}/R_{(A+B+other)} of the total of the component A and the component B to the total of the component A, the component B, and the other component may be determined in the same manner as in the determination of the composition ratio of the component B to the component A. That is, when there are “n” kinds of the other components, the k-th other component (other k-th) is determined for R_{other k-th} based on an element derived from the other k-th in the same manner as in the R_{A} and the R_{B}, and Rₒₜₕₑᵣ is determined as a total of the “n” components. However, an oxygen atom is not regarded as the other component, and the oxygen atom is not included in the calculation of R_{(A+B)}/R_{(A+B+other)}.

$${R}_{other} = {\sum }_{k = 1}^{n} {R}_{other k - th}$$

The surface of the solid material of the present disclosure may contain any compound except the component A and the component B to the extent that the effects of the present disclosure are not impaired.

The component A′ in the surface forming material of the present disclosure is described below. The component A′ is a component containing a silicon compound having an alkoxy group, and is preferably an alkoxysilane. The alkoxysilane is represented by the general formula: H₂ₙ₊₁CₙO(Si(OCₙH₂ₙ₊₁)₂O)ₘCₙH₂ₙ₊₁. It is preferred that the “n” represent 1 or more and 4 or less, and the “m” represent 1 or more and 100 or less. Preferred examples of the alkoxy group may include a methoxy group, an ethoxy group, a propoxy group, and a butoxy group. The “m” preferably represents 4 or more and 50 or less, more preferably 6 or more and 10 or less. Specific examples of the silicon compound having an alkoxy group include methyl polysilicate (Methyl Polysilicate 53A (A′-1), manufactured by Colcoat Co., Ltd.), butyl polysilicate (A′-2), and ethyl polysilicate (Ethyl Polysilicate 48 (A′-3), manufactured by Colcoat Co., Ltd.). The component A is obtained by allowing the hydrolysis reaction of the component A′ to proceed in an acidic aqueous solution.

### First Embodiment

FIG. 1 is a schematic view for illustrating the configuration in a first embodiment of a solid material of the present disclosure, and a configuration example in which a base layer is formed on a base material, and the base layer has a surface thereon is illustrated. FIG. 1 is an illustration of the configuration in which the base layer 12 is present on the base material 11, and the surface 13 is formed on the base layer 12. The solid material may include the base material 11, the base layer 12, and the surface 13, may be the base layer 12 and the surface 13, or may be the surface 13. FIG. 1 is a schematic illustration of the configuration including the surface, and differs from an illustration of the actual thicknesses of the base material 11, the base layer 12, and the surface 13 in accurate proportions.

### (Base Material 11)

It is only required that the base material 11 be solid and capable of allowing the base layer 12, the surface 13, or an intermediate layer 14 or a hard coat layer 15 described later to be formed thereon. Examples of the base material 11 include glass, a ceramic, a resin, or a metal, and a film formed of glass or a resin. When any one of the above-mentioned materials is used as the base material of the optical member including the surface of the present disclosure, the base material is not particularly limited.

The thickness of the base material is not particularly limited and may be appropriately set in accordance with applications.

### (Base Layer 12)

As required, a base layer may be formed. The base layer 12 is a layer serving as a base on which the surface 13 is formed, and ensures satisfactory adhesiveness between the base material 11 and the surface 13.

In this embodiment, in order to further improve the adhesiveness between the base material 11 and the surface 13, the base layer 12 is formed on the base material 11, and the surface 13 is formed on the base layer 12. A method of forming the base layer is not particularly limited, but examples thereof include a vapor deposition method, a dipping method, a coating method, a spraying method, and a spin coating method.

Although the thickness of the base layer 12 is not particularly limited, the thickness is from 2 nm to 150 nm, preferably from 5 nm to 125 nm.

The base layer 12 preferably has a hydroxy group on a surface thereof. Examples of a material of the base layer 12 include a metal oxide having a hydroxy group on a surface thereof, such as SiO₂ or Al₂O₃, and an alkyl compound having a hydroxy group.

### (Surface 13)

The surface 13 is the surface of the solid material of the present disclosure.

The thickness of the surface 13 is not particularly limited, but is preferably from 3 nm to 20 nm. When the thickness is 3 nm or more, a sufficient antifogging property is obtained. When the thickness is 20 nm or less, transparency is satisfactory.

### Second Embodiment

FIG. 2 is a schematic view for illustrating the configuration in a second embodiment of a solid material of the present disclosure, and a configuration example in which the intermediate layer 14 is formed on the base material, the base layer 12 is formed on the intermediate layer, and the base layer 12 has the surface 13 thereon is illustrated.

In FIG. 2, the intermediate layer 14 in which intermediate layers 14a and 14c each including a low-refractive-index material, and intermediate layers 14b and 14d each including a high-refractive-index material are alternately deposited is formed on the base material 11. The solid material may include the base material 11, the intermediate layer 14, the base layer 12, and the surface 13, or may be each layer (14, 12) and the surface 13 excluding the base material, or may be the surface 13.

FIG. 2 is a schematic illustration of the configuration including the surface, and the actual thicknesses of the base material 11, the intermediate layer 14, the base layer 12, and the surface 13 in accurate proportions are not illustrated.

### (Intermediate Layer 14)

As illustrated in FIG. 2, in the intermediate layer 14, the intermediate layers 14a and 14c laminated at odd-numbered positions counted from the base material 11 side each include a low-refractive-index material, and the intermediate layers 14b and 14d laminated at even-numbered positions counted from the base material 11 side each include a high-refractive-index material. The intermediate layer may have an antireflection function.

In this embodiment, it is preferred that the base layer 12 be also formed of a low-refractive-index material, be laminated on the intermediate layer 14, and exhibit an antireflection function together with the intermediate layer 14. In this embodiment, as an example, the intermediate layer 14 includes four layers, and the base layer 12 is formed on the intermediate layer 14d including a high-refractive-index material. Thus, it is preferred that the base layer 12 be formed of a low-refractive-index material.

As the intermediate layer 14 in this embodiment, an example having a four-layer configuration is given. However, the present disclosure is not limited thereto in any way, and the number of layers may be any number. In addition, a layer formed of a medium-refractive-index material may be appropriately laminated.

Examples of the low-refractive-index material include silicon dioxide (SiO₂) and alumina-doped silicon dioxide (Al₂O₃-doped SiO₂). However, the low-refractive-index material is not limited thereto.

Examples of the high-refractive-index material include an alumina-containing titanium oxide-lanthanum oxide-based mixed material, titanium oxide, another mixed oxide containing titanium oxide as a main component, zirconium oxide, a mixed material containing zirconium oxide as a main component, niobium oxide, a mixed material containing niobium oxide as a main component, tantalum oxide, a mixed material containing tantalum oxide as a main component, tungsten oxide, and a mixed material containing tungsten oxide as a main component. However, the high-refractive-index material is not limited thereto.

Examples of the medium-refractive-index material include aluminum oxide, another mixture containing aluminum oxide as a main component, magnesium oxide, another mixed compound containing magnesium oxide as a main component, yttrium fluoride, and cerium fluoride. However, the medium-refractive-index material is not limited thereto.

The thicknesses of the intermediate layer 14 and each layer (14a, 14b, 14c, and 14d in FIG. 2) for forming the intermediate layer 14 are not particularly limited. However, the intermediate layer 14 may be formed, for example, by setting the thickness of each layer forming the intermediate layer 14 to from 10 nm to 200 nm and laminating a required number of layers.

In addition, although this embodiment includes the intermediate layer 14 as a part of the antireflection film formed by alternately laminating the low-refractive-index layer and the high-refractive-index layer as described above, the present disclosure is not limited thereto in any way. For example, at least one layer having a function selected from other filters or mirrors, an antistatic hard coat, an anti-scratch hard coat, and the like may be formed between the base material 11 and the intermediate layer 14.

The base material 11, the base layer 12, and the surface 13 in the second embodiment of the surface may be the same as those in the first embodiment of the surface.

### «Optical Member»

FIG. 3 is a schematic view for illustrating the configuration in a first embodiment of an optical member.

In this embodiment, the optical member is used for an eyeglass lens or other applications.

The optical member in FIG. 3 includes the base material 11 made of a resin, the hard coat layer 15 for scratch prevention, the intermediate layer 14 having an antireflection function as described above in the second embodiment of the solid material, the base layer 12, and the surface 13. In FIG. 3, the intermediate layer 14 has a two-layer configuration in which the intermediate layer 14a laminated at an odd-numbered position counted from the base material 11 side is formed of a low-refractive-index material, and the intermediate layer 14b laminated at an even-numbered position counted from the base material 11 side is formed of a high-refractive-index material. However, the present disclosure is not limited thereto, and the number of layers may be any number. In addition, a layer formed of a medium-refractive-index material may be appropriately laminated.

In addition, as the hard coat layer 15, for example, a melamine resin, a urethane resin, an acrylic resin, or a mixture of those resins, or a silane compound may be used. However, the material to be used for the hard coat layer 15 is not limited thereto.

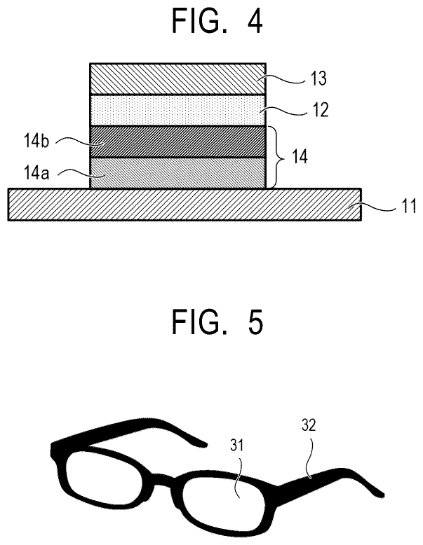

FIG. 4 is a schematic view for illustrating the configuration in a second embodiment of an optical member.

In this embodiment, the optical member is used for an optical lens to be used in a camera or the like, an optical filter, a touch panel for a display, various films, or other applications, and is particularly preferably used as an optical lens for a camera.

The optical member in FIG. 4 includes the base material 11 made of glass, the intermediate layer 14 having an antireflection function as described above in the second embodiment of the solid material, the base layer 12, and the surface 13. In FIG. 4, the intermediate layer 14 has a two-layer configuration in which the intermediate layer 14a laminated at an odd-numbered position counted from the base material 11 side is formed of a low-refractive-index material, and the intermediate layer 14b laminated at an even-numbered position counted from the base material 11 side is formed of a high-refractive-index material. However, the present disclosure is not limited thereto, and the number of layers may be any number. In addition, layers each formed of a medium-refractive-index material may be appropriately laminated.

### «Pair of Eyeglasses»

FIG. 5 is a schematic view for illustrating the configuration in one embodiment of a pair of eyeglasses using the optical member of the present disclosure. This embodiment includes eyeglass lenses 31 that are each the optical member of the present disclosure described above, and an eyeglass frame 32.

### EXAMPLES

The present disclosure is more specifically described below by way of Examples, but the present disclosure is not limited to the following Examples.

### Example 1

### (Production of Surface Forming Material)

The combinations of the component A′ and the component B, and the mass ratios of the component B to the component A′ are shown in Table 1-1. Substance names and product names corresponding to symbols in Table 1-1 are shown in Table 1-2. In Example 1, methyl polysilicate (manufactured by Colcoat Co., Ltd., product name: Methyl Silicate 53A, average molecular weight: 789.2) (A′-1) serving as the component A′ and a maleic anhydride-modified product of an ethylene-propylene copolymer (manufactured by Mitsui Chemicals, Inc., product name: Hi-WAX Acid Modified Type 1105A, molecular weight: 1,500) (B-1) serving as the component B were blended in a metal container so that the mass ratio of the component B to the component A was 0.10 to provide a surface forming material (Production Example 1).

### (Production of Base Layer)

The base layer 12 formed of SiO₂ having a thickness of 10 nm was formed on borosilicate glass having a thickness of 3 mm that was the base material 11, with a vacuum vapor deposition device (dome diameter: $900 mm, vapor deposition distance: 890 mm) by a vapor deposition method. The thickness of the base layer 12 was measured by spectroscopic ellipsometry (ESM300, manufactured by J.A. Woollam Co., Inc.).

### (Formation of Surface)

The surface forming material of Production Example 1 was deposited from the vapor on the base layer 12 with a vacuum vapor deposition device (dome diameter: $900 mm, vapor deposition distance: 890 mm). The base material 11 in which the surface forming material of Production Example 1 was deposited from the vapor on the base layer 12 was immersed in 50 ml of hydrochloric acid having a concentration of 0.01 mol/L for 16 hours to accelerate the hydrolysis reaction of methyl polysilicate. Thus, the surface 13 formed of SiO₂ and a maleic anhydride-modified product of an ethylene-propylene copolymer was formed to provide a solid material. After the solid material was pulled up from the hydrochloric acid, the solid material was dried by air blowing, and an optical member including the solid substance was produced. The thickness of the surface 13 was measured by spectroscopic ellipsometry (ESM300, manufactured by J.A. Woollam Co., Inc.) to be 6 nm. In addition, the composition ratio of the component B to the component A in the resultant surface was measured by X-ray photoelectron spectroscopy to be 2.26.

### (Evaluation of Antifogging Characteristic)

The haze difference of the surface of the produced optical member was measured by the following method.

A spectrophotometer CM-5 manufactured by Konica Minolta, Inc. was used as a measurement device for the haze difference. Steam at about 100° C. was sprayed onto the optical member with a humidifier, and the haze difference was measured after 3 seconds. The antifogging characteristic was evaluated in the following four levels of from A to D based on the measured haze difference. The results are shown in Table 2.
A: Haze difference of less than 1
B: Haze difference of from 1 to less than 15
C: Haze difference of from 15 to less than 35
D: Haze difference of 35 or more

### (Evaluation of Frictional Force)

The frictional force of the surface of the produced optical member was measured by the following method.

An automatic friction and wear analysis device Triboster 500 manufactured by Kyowa Interface Science Co., Ltd. was used as a measurement device for the frictional force. CLINT paper (COTTON WIPER CLINT UW-1A, manufactured by UNITIKA LTD.) cut to a size of 1 cm² was used as a contact element for measuring the frictional force, and the frictional force was measured by bringing the CLINT paper into contact with the surface of the optical member. In this case, a test was performed by adjusting the applied load of the device so that the load applied to the surface was 0.49 kgf. The test was performed under the condition of a friction speed of 2.5 mm/sec. The results are shown in Table 2.

### Examples 2 to 27

Surface forming materials (Production Examples 2 to 27) were each produced by blending in a metal container in the same manner as in Production Example 1 except that the compound shown in Table 1-1 to be used as the component A′, the compound shown in Table 1-1 to be used as the component B, and the composition ratio of the component B to the component A after the formation of the surface were each changed as shown in Table 2. Solid materials of Examples 2 to 27 were obtained in the same manner as in Example 1 through use of the surface forming materials of Production Examples 2 to 27 to produce optical members. In addition, the evaluation of the frictional force and the evaluation of the antifogging performance were performed in the same manner as in Example 1. The results are shown in Table 2.

### Example 28

A surface forming material (Production Example 1) was produced by blending in a metal container in the same manner as in Example 1. After that, the surface forming material of the above-mentioned Production Example 1 and Al₂O₃ were deposited from the vapor on the base layer 12 with a vacuum vapor deposition device. The ratio between the surface forming material and Al₂O₃ was adjusted so that R_{(A+B)}/R_{(A+B+other)} was 0.99. The resultant was immersed in hydrochloric acid to accelerate the hydrolysis reaction in the same manner as in Example 1. Thus, a solid material of Example 28 was obtained to produce an optical member. The evaluation of the frictional force and the evaluation of the antifogging performance were performed in the same manner as in Example 1. The results are shown in Table 2.

### Comparative Example 1

Only methyl polysilicate (manufactured by Colcoat Co., Ltd., product name: Methyl Silicate 53A, average molecular weight: 789.2) was injected into a metal container to produce a surface forming material (Production Comparative Example 1). The surface forming material of Production Comparative Example 1 was deposited from the vapor on the base layer in the same manner as in Example 1. The resultant was immersed in hydrochloric acid to accelerate the hydrolysis reaction in the same manner as in Example 1. Thus, a solid material of Comparative Example 1 was obtained to produce an optical member. In addition, the evaluation of the frictional force and the evaluation of the antifogging performance were performed in the same manner as in Example 1. The results are shown in Table 2.

### Comparative Example 2

Only a maleic anhydride-modified product of an ethylene-propylene copolymer (manufactured by Mitsui Chemicals, Inc., product name: Hi-WAX Acid Modified Type 1105A, molecular weight: 1,500) was injected into a metal container to produce a surface forming material (Production Comparative Example 2). The surface forming material of Production Comparative Example 2 was deposited from the vapor on the base layer in the same manner as in Example 1. Thus, a solid material of Comparative Example 2 was obtained to produce an optical member. In addition, the evaluation of the frictional force and the evaluation of the antifogging performance were performed in the same manner as in Example 1. The results are shown in Table 2.

### Comparative Example 3

Only a styrene-grafted product of an ethylene-propylene copolymer (manufactured by Mitsui Chemicals, Inc., product name: Hi-WAX Special Monomer Modified Type 1120H) was injected into a metal container to produce a surface forming material (Production Comparative Example 3). The surface forming material of Production Comparative Example 3 was deposited from the vapor on the base layer in the same manner as in Example 1. Thus, a solid material of Comparative Example 3 was obtained to produce an optical member. In addition, the evaluation of the frictional force and the evaluation of the antifogging performance were performed in the same manner as in Example 1. The results are shown in Table 2.

### Comparative Example 4

Only cerium stearate was injected into a metal container to produce a surface forming material (Production Comparative Example 4). The surface forming material of Production Comparative Example 4 was deposited from the vapor on the base layer in the same manner as in Example 1. Thus, a solid material was obtained to produce an optical member. In addition, the evaluation of the frictional force and the evaluation of the antifogging performance were performed in the same manner as in Example 1. The results are shown in Table 2.

### Comparative Example 5

Methyl polysilicate (manufactured by Colcoat Co., Ltd., product name: Methyl Silicate 53A, average molecular weight: 789.2) serving as the component A′ and aluminum laurate serving as the component B were blended in a metal container so that the mass ratio of the component B to SiO₂ of the component A was 0.10 to produce a surface forming material (Production Comparative Example 5). The surface forming material of Production Comparative Example 5 was deposited from the vapor on the base layer in the same manner as in Example 1. The resultant was immersed in hydrochloric acid to accelerate the hydrolysis reaction in the same manner as in Example 1. Thus, a solid material of Comparative Example 5 was obtained to produce an optical member. In addition, the evaluation of the frictional force and the evaluation of the antifogging performance were performed in the same manner as in Example 1. The results are shown in Table 2.

### Comparative Examples 6 to 10

Surface forming materials (Production Comparative Examples 6 to 10) were each produced by blending in a metal container in the same manner as in Example 1 except that the compound shown in Table 1-1 to be used as the component A′, the compound shown in Table 1-1 to be used as the component B, and the composition ratio of the component B to the component A after the formation of the surface were each changed as shown in Table 2. The surface forming material of each of Production Comparative Examples was deposited from the vapor on the base layer in the same manner as in Example 1. The resultant was immersed in hydrochloric acid to accelerate the hydrolysis reaction in the same manner as in Example 1. Thus, a solid material of each of Comparative Examples was obtained to produce an optical member. In addition, the evaluation of the frictional force and the evaluation of the antifogging performance were performed in the same manner as in Example 1. The results are shown in Table 2.

### Example 29

The optical members (glass lenses) obtained in Example 1 were processed and mounted to a commercially available frame to create a pair of eyeglasses. The glass lenses of the pair of eyeglasses thus created were evaluated for an antifogging characteristic in the same manner as in Example 1, and the evaluation result was “B”.

TABLE 1
Table 1-1

| | | | Component B/ |
|---|---|---|---|
| | Component | Component | Component A′ |
| Production No. | A′ | B | (mass ratio) |
| Production Example 1 | A′-1 | B-1 | 0.10 |
| Production Example 2 | A′-1 | B-1 | 0.01 |
| Production Example 3 | A′-1 | B-2 | 0.01 |
| Production Example 4 | A′-1 | B-3 | 0.01 |
| Production Example 5 | A′-1 | B-3 | 0.02 |
| Production Example 6 | A′-1 | B-2 | 0.03 |
| Production Example 7 | A′-1 | B-4 | 0.05 |
| Production Example 8 | A′-1 | B-5 | 0.05 |
| Production Example 9 | A′-1 | B-5 | 0.07 |
| Production Example 10 | A′-1 | B-1 | 0.08 |
| Production Example 11 | A′-1 | B-4 | 0.08 |
| Production Example 12 | A′-1 | B-6 | 0.10 |
| Production Example 13 | A′-1 | B-5 | 0.10 |
| Production Example 14 | A′-2 | B-1 | 0.10 |
| Production Example 15 | A′-1 | B-4 | 0.10 |
| Production Example 16 | A′-1 | B-7 | 0.10 |
| Production Example 17 | A′-1 | B-8 | 0.10 |
| Production Example 18 | A′-1 | B-5 | 0.10 |
| Production Example 19 | A′-1 | B-5 | 0.19 |
| Production Example 20 | A′-1 | B-9 | 0.05 |
| Production Example 21 | A′-1 | B-6 | 0.21 |
| Production Example 22 | A′-1 | B-7 | 0.21 |
| Production Example 23 | A′-1 | B-9 | 0.41 |
| Production Example 24 | A′-3 | B-1 | 0.41 |
| Production Example 25 | A′-3 | B-6 | 0.41 |
| Production Example 26 | A′-3 | B-10 | 0.41 |
| Production Example 27 | A′-3 | B-11 | 0.41 |
| Production Comparative | A′-1 | — | 0.00 |
| Example 1 | | | |
| Production Comparative | — | B-1 | — |
| Example 2 | | | |
| Production Comparative | — | B-5 | — |
| Example 3 | | | |
| Production Comparative | — | B-9 | — |
| Example 4 | | | |
| Production Comparative | A′-1 | B-12 | 0.10 |
| Example 5 | | | |
| Production Comparative | A′-1 | B-1 | 0.53 |
| Example 6 | | | |
| Production Comparative | A′-1 | B-1 | 0.01 |
| Example 7 | | | |
| Production Comparative | A′-1 | B-5 | 0.01 |
| Example 8 | | | |
| Production Comparative | A′-1 | B-9 | 0.01 |
| Example 9 | | | |
| Production Comparative | A′-1 | B-2 | 0.01 |
| Example 10 | | | |

Table 1-2

| Symbol | Product name | Substance name |
|---|---|---|
| A′-1 | Methyl Silicate 53A | Methyl polysilicate |
| A′-2 | Butyl Polysilicate | Butyl polysilicate |
| A′-3 | Ethyl Silicate 48 | Ethyl polysilicate |
| B-1 | Hi-WAX 1105A | Maleic anhydride- |
| | | modified product of |
| | | ethylene-propylene |
| | | copolymer |
| B-2 | Hi-WAX 4202E | Oxidized product of |
| | | low-molecular-weight |
| | | ethylene-propylene |
| | | copolymer |
| B-3 | Hi-WAX 220MP | Oxidized product of |
| | | low-molecular-weight |
| | | ethylene-propylene |
| | | copolymer |
| B-4 | Hi-WAX 110P | Low-molecular-weight |
| | | ethylene-propylene |
| | | copolymer |
| B-5 | Hi-WAX 1120H | Styrene-grafted product |
| | | of low-molecular-weight |
| | | ethylene-propylene |
| | | copolymer |
| B-6 | Hi-WAX 100P | Low-molecular-weight |
| | | polyethylene |
| B-7 | Hi-WAX 210P | Low-molecular-weight |
| | | ethylene-propylene |
| | | copolymer |
| B-8 | Hi-WAX 720P | Low-molecular-weight |
| | | ethylene-propylene |
| | | copolymer |
| B-9 | Cerium stearate | Cerium stearate |
| B-10 | Aluminum stearate | Aluminum stearate |
| B-11 | Calcium stearate | Calcium stearate |
| B-12 | Aluminum laurate | Aluminum laurate |

TABLE 2

| | | | | Component B/ |
|---|---|---|---|---|
| | | | | Component A |
| | | Evaluation | Frictional | (composition |
| | Production No. | of fogging | force [g] | ratio) |
| Example 1 | Production | B | 28.9 | 2.26 |
| | Example 1 | | | |
| Example 2 | Production | B | 53.2 | 0.23 |
| | Example 2 | | | |
| Example 3 | Production | B | 47.7 | 0.23 |
| | Example 3 | | | |
| Example 4 | Production | B | 39.9 | 0.23 |
| | Example 4 | | | |
| Example 5 | Production | B | 26.1 | 0.45 |
| | Example 5 | | | |
| Example 6 | Production | B | 60.1 | 0.61 |
| | Example 6 | | | |
| Example 7 | Production | B | 35.8 | 1.13 |
| | Example 7 | | | |
| Example 8 | Production | B | 36.4 | 1.13 |
| | Example 8 | | | |
| Example 9 | Production | B | 50.5 | 1.62 |
| | Example 9 | | | |
| Example 10 | Production | B | 25.6 | 1.70 |
| | Example 10 | | | |
| Example 11 | Production | B | 25.9 | 1.70 |
| | Example 11 | | | |
| Example 12 | Production | B | 32.9 | 2.09 |
| | Example 12 | | | |
| Example 13 | Production | B | 25.9 | 2.09 |
| | Example 13 | | | |
| Example 14 | Production | B | 29.3 | 2.26 |
| | Example 14 | | | |
| Example 15 | Production | B | 37.1 | 2.26 |
| | Example 15 | | | |
| Example 16 | Production | B | 55.8 | 2.26 |
| | Example 16 | | | |
| Example 17 | Production | B | 26.8 | 2.26 |
| | Example 17 | | | |
| Example 18 | Production | B | 28.2 | 2.26 |
| | Example 18 | | | |
| Example 19 | Production | B | 20.3 | 4.18 |
| | Example 19 | | | |
| Example 20 | Production | B | 38.0 | 1.13 |
| | Example 20 | | | |
| Example 21 | Production | B | 39.0 | 4.53 |
| | Example 21 | | | |
| Example 22 | Production | B | 39.8 | 4.53 |
| | Example 22 | | | |
| Example 23 | Production | B | 31.0 | 8.86 |
| | Example 23 | | | |
| Example 24 | Production | C | 18.3 | 8.87 |
| | Example 24 | | | |
| Example 25 | Production | C | 29.0 | 8.89 |
| | Example 25 | | | |
| Example 26 | Production | B | 49.2 | 8.89 |
| | Example 26 | | | |
| Example 27 | Production | C | 37.9 | 8.89 |
| | Example 27 | | | |
| Example 28 | Production | B | 29.0 | 2.26 |
| | Example 1 | | | |
| Example 29 | Production | B | 28.9 | 2.26 |
| | Example 1 | | | |
| Comparative | Production | A | 65.2 | 0.00 |
| Example 1 | Comparative | | | |
| | Example 1 | | | |
| Comparative | Production | D | 12.0 | — |
| Example 2 | Comparative | | | |
| | Example 2 | | | |
| Comparative | Production | D | 16.2 | — |
| Example 3 | Comparative | | | |
| | Example 3 | | | |
| Comparative | Production | D | 28.0 | — |
| Example 4 | Comparative | | | |
| | Example 4 | | | |
| Comparative | Production | C | 65.0 | 2.30 |
| Example 5 | Comparative | | | |
| | Example 5 | | | |
| Comparative | Production | D | 13.0 | 11.52 |
| Example 6 | Comparative | | | |
| | Example 6 | | | |
| Comparative | Production | A | 64.5 | 0.12 |
| Example 7 | Comparative | | | |
| | Example 7 | | | |
| Comparative | Production | A | 66.1 | 0.12 |
| Example 8 | Comparative | | | |
| | Example 8 | | | |
| Comparative | Production | B | 63.0 | 0.12 |
| Example 9 | Comparative | | | |
| | Example 9 | | | |
| Comparative | Production | B | 73.6 | 0.16 |
| Example 10 | Comparative | | | |
| | Example 10 | | | |

What is claimed is:

1. A solid material comprising a surface containing at least a component A and a component B,
wherein the component A is a silicon compound having a silanol group,
wherein the component B is a compound having an alkyl group having 18 or more carbon atoms in a main chain, and
wherein a composition ratio R_{B}/R_{A} of the component B to the component A in the surface is 0.23 or more and 8.89 or less.

2. The solid material according to claim 1,
wherein the surface is formed of the component A, the component B, and another component, and
wherein a composition ratio R_{(A+B)}/R_{(A+B+other)} of a total of the component A and the component B to a total of the component A, the component B, and the another component in the surface is 0.95 or more.

3. The solid material according to claim 1, wherein the component B contains at least one selected from a polyolefin and a fatty acid salt.

4. The solid material according to claim 3, wherein the polyolefin contains at least one selected from the group consisting of: polyethylene (e.g., LDPE, HDPE, or MDPE); polypropylene; and a copolymer of polyethylene and polypropylene.

5. The solid material according to claim 3, wherein the fatty acid salt is a salt formed of at least one metal element selected from the group consisting of: an alkali metal; an alkaline earth metal; and a transition metal, and a saturated fatty acid or an unsaturated fatty acid.

6. The solid material according to claim 3, wherein the fatty acid salt contains at least one selected from the group consisting of: cerium stearate; aluminum stearate; and calcium stearate.

7. The solid material according to claim 1, wherein the component A further contains silicon dioxide.

8. An optical member comprising the solid material of claim 1.

9. A pair of eyeglasses comprising the optical member of claim 8.

10. A surface forming material comprising at least a component A′ and a component B,
wherein the component A′ is a silicon compound having an alkoxy group,
wherein the component B is a compound having an alkyl group having 18 or more carbon atoms in a main chain, and
wherein a mass ratio of the component B to the component A′ in the surface forming material is 0.01 or more and 0.41 or less.

11. The surface forming material according to claim 10, wherein the component B contains at least one selected from a polyolefin and a fatty acid salt.

12. The surface forming material according to claim 11, wherein the polyolefin contains at least one selected from the group consisting of: polyethylene; polypropylene; and a copolymer of polyethylene and polypropylene.

13. The surface forming material according to claim 11, wherein the fatty acid salt is a salt formed of at least one metal element selected from the group consisting of: an alkali metal; an alkaline earth metal; and a transition metal, and a saturated fatty acid or an unsaturated fatty acid.

14. The surface forming material according to claim 11, wherein the fatty acid salt contains at least one selected from the group consisting of: cerium stearate; aluminum stearate; and calcium stearate.

15. The surface forming material according to claim 10, wherein the component A′ is an alkoxysilane.

16. The surface forming material according to claim 10, wherein the alkoxy group is one selected from the group consisting of: a methoxy group; an ethoxy group; a propoxy group; and a butoxy group.

17. An optical member comprising a surface formed through use of the surface forming material of claim 10.

18. A pair of eyeglasses comprising the optical member of claim 17.
